(19) United States
(12) Patent Application Publication
(10) Pub. No.: US 2016/0185410 A1
(43) Pub. Date: Jun. 30, 2016

(54) MOTORCYCLE PROTECTIVE CAGE WITH SHOCK ABSORPTION

(71) Applicant: Kia Khoda, Los Angeles, CA (US)

(72) Inventor: Kia Khoda, Los Angeles, CA (US)

(21) Appl. No.: 14/587,227

(22) Filed: Dec. 31, 2014

(51) Int. Cl. B62J 23/00; F16F 9/10; F16F 9/02

(52) U.S. Cl. CPC B62J 23/00; F16F 9/02; F16F 9/10

(57) ABSTRACT

A motorcycle protective cage with shock absorber utilized to prevent motorcycle damage when the motorcycle is dropped or a fall ensues. The motorcycle cage includes metal tubing, multiple fastening locations, and one or more shock absorption features. The shock absorber has a hard outer material and a compressible inner material. After application of force the firm outer material makes contact with the compressible inner material, hereafter mitigating transfer of force and shock into the motorcycle and its components.

### REFERENCES CITED

| Cited Patent | Filing date | Publication date | Applicant | Title |
|---|---|---|---|---|
| U.S. Pat. No. 1,473,956 | Jun. 21, 1922 | Nov. 13, 1923 | Cleo H Crites | Attachment for motor cycles |
| U.S. Pat. No. 1,941,801 | Jan. 5, 1933 | Jan. 2, 1934 | Harley Davidson Motor Co Inc | Motorcycle protecting guard |
| U.S. Pat. No. 3,902,740 | Feb. 13, 1974 | Sep. 2, 1975 | Cycle Service Center Inc | Motorcycle engine guard assembly |
| U.S. Pat. No. 4,030,561 | Jan. 29, 1976 | Jun. 21, 1977 | Honda Giken Kogyo Kabushiki | Safety kickstarter for motorcycles |
| | | | Kaisha | |
| U.S. Pat. No. 4,377,295 | Jun. 1, 1981 | Mar. 22, 1983 | Lemman Cecil L | Apparatus for uprighting a motorized |
| | | | | two-wheeled vehicle |
| U.S. Pat. No. 4,416,465 | Dec. 8, 1980 | Nov. 22, 1983 | Martha Winiecki | Crash resistant motorcycle |
| U.S. Pat. No. 4,451,057 | Jan. 25, 1982 | May 29, 1984 | Lawson Louis L | Foot-rest device for motorcycles |
| U.S. Pat. No. 4,673,190 | Nov. 6, 1985 | Jun. 16, 1987 | Ahlberg Russell W | Protective bar assembly for motorcycle |
| U.S. Pat. No. 4,728,121 | Feb. 9, 1987 | Mar. 1, 1988 | Graves Elmer L | Foot protector apparatus for multi-wheeled |
| | | | | recreational vehicles |
| U.S. Pat. No. 4,768,799 | Dec. 16, 1986 | Sep. 6, 1988 | Millican Edwin E | Motorcycle footguard |
| U.S. Pat. No. 4,813,706 | Sep. 9, 1987 | Mar. 21, 1989 | Dan Kincheloe | Roll cage for personal motorized vehicles |
| U.S. Pat. No. 4,852,900 | May 12, 1988 | Aug. 1, 1989 | Nahachewski Vladimir W | Foot guards for all terrain vehicles |
| U.S. Pat. No. 5,106,136 | Jul. 12, 1991 | Apr. 21, 1992 | Grain William E | Motorcycle bumper system |
| U.S. Pat. No. 5,257,671 | Nov. 28, 1990 | Nov. 2, 1993 | Jonathan Watkins | Vehicle |
| U.S. Pat. No. 5,704,442 | Jun. 6. 1995 | Jan. 6, 1998 | Honda Giken Kogyo Kabushiki | Frame structure for a motorcycle |
| | | | Kaisha | |
| U.S. Pat. No. 5,743,561 | Sep. 14, 1995 | Apr. 28, 1998 | Kim; Sinil | Light motorcycle roll bar |
| U.S. Pat. No. 6,116,630 | Feb. 4, 1999 | Sep. 12, 2000 | Thomas; Kenneth Eugene | All terrain vehicle foot rest |
| U.S. Pat. No. 6,161,859 | Dec. 21, 1998 | Dec. 19, 2000 | Cheng; Chun Ling | Foot pegs for motorcycles |
| U.S. Pat. No. 6,663,129 | Sep. 21, 1999 | Dec. 16, 2003 | Technical Edge Pty. Limited | Motorcycle pivoting foot pegs |
| U.S. Pat. No. 7,025,368* | Dec. 10, 2003 | Apr. 11, 2006 | Barnes Timothy E | Protective cage for motorcycle engine |

### FIELD

Various exemplary embodiments discussed herein are directed to a protective motorcycle cage having one or more compressible impact absorption mechanism therein.

### BACKGROUND OF INVENTION

Many motorcycle riders perform a variety difficult stunts and maneuvers. For example: front or rear tire wheelies while the motorcycle is rotating in a tight controlled spin. Performing these maneuvers is called stunt riding. Due to the inherently difficult nature of stunt riding, the motorcycle operator may fall or drop the motorcycle on its side. Henceforth, potentially causing the motorcycle to hit the ground with extremely high impacts. As a result of a fall or drop, irreversible damage to the motorcycles components: the frame, engine, body, excreta may supervene.

Like stunt riding, motorcycle racing in its nature is also intrinsically difficult. Motorcyclists, while racing, sometimes fall, subjecting the motorcycle to high impacts while making contact with the ground. Subsequently, after a fall, additional vigorous impacts may ensue as the motorcycle slides on its side at high speeds over uneven surfaces. For the duration of the accident, powerful impacts to the motorcycle may be accumulated. Like stunt riding, the chance of a fall is larger relative to normal motorcycle operation. The impacts that racing or stunt motorcycles amass are at times extremely energetic and damaging. Powerful enough to cause irreversible damage to the motorcycle and its components.

Although stunt riding and motorcycle racing present a higher risk of motorcycle damage after a fall, a motorcycle can also accumulate damaged under normal operation. A motorcyclist may fall or drop the motorcycle on its side under normal operation for a variety of reasons: bad footing, slippery road, flat tire, unexpected obstacles, excreta.

For these reasons previously stated there is obviously a need for products used to protect a motorcycle from damage during a fall or drop which exerts forcefully damaging impacts. Various products and publications have been created in an attempt to preclude or mitigate damage to a motorcycle when a fall transpires. Today, the use of plastic “sliders” are implemented for contacting the ground and protecting the motorcycles. Although, when highly forceful impacts occur, sliders do little to absorb the impact and do not provide complete protection to the motorcycles engine, frame, body or other fragile components. Due to their inherent firmness these sliders can transfer force into the motorcycle frame, engine or other components. Consecutively, transferring forces into the motorcycle components that exceed the material sheering and bending forces, henceforth causing irreversible damage to the fallen motorcycle.

Other products have been designed to provide a greater level of protection to the motorcycle as seen in patent CN103754299 A and U.S. Pat. No. 7,159,887 B2. Although these designs provides a greater level of protection then motorcycle sliders, the use of “ridged tubing” does little to mitigate the transfer the force into the motorcycle and its components. Additionally, these types of exoskeleton frames are perishable items. After highly forceful impacts and after ensuing some damage the exoskeleton cage may need to be replaced. CN103754299 A: “Since the motorcycle engine protection cage often collide with the ground occurs, so they need frequent replacement. With this structure, according to the extent of damage to the different parts to be replaced, saving the cost.”

Other protective cages like that seen in patent U.S. Pat. No. 7,159,887 B2 have a ridged design. The use of ridged tubing does not provide the best solution for impact absorption. Under high impacts it easily transfers forceful energy into the fragile components of the motorcycle due to the lack of shock absorption ability. U.S. Pat. No. 7,159,887 B2 “The “U” shaped brace is formed of rigid metal tubing. The brace can also be formed of other materials having the necessary strength and rigidity”

### SUMMARY OF THE INVENTION

The technical problem to be solved by the present invention comprises: damage caused to the motorcycle when the motorcycle makes forceful contact with the ground after a drop or fall, thereby enabling the disadvantages of damage to the motorcycle and its components.

In order to solve the above technical problem, the present invention provides a motorcycle protective cage, comprising one or more compressible absorption mechanisms built into said protective cage.

The shock absorption frame is U-shaped, Y shaped, V-shaped, or triangular and is consistent of supporting trusses therein.

Sliders are designed so only the sliders make contact with the ground. No portion of the motorcycle, its components or metal tubing of the cage will make ground contact when the motorcycle falls on its side.

When the motorcycle makes contact with the ground, it is important for the sliders to contact the ground first, before any other components. When the slider makes contact it does so in an even and uniform manor. Thus distributing the force equally throughout the entire slider.

Upon impact the slider is designed to compress into the slider housing, which is secured to the exoskeleton cage. The exoskeleton cage is secured to the motorcycle.

The shock absorber mechanism is consistent of: the shock absorber housing, slider which is a hard outer material that makes contact with the ground, a compressible inner shock absorber, as well as necessary hardware for securing the slider and compressible material inside of the shock absorbing housing.

High strength slides are designed to be resilient and durable, after receiving a force they are designed to transfer energy to a compressible shock absorber or compressible material without breaking. The said compressible material then condenses, absorbing the impact, providing superior protection to the motorcycle and its components.

After application of force the firm outer material makes contact with the compressible inner material, thus transferring the force to the compressible inner material. Henceforth compressible inner material absorbs shock.

The above solution motorcycle exoskeleton protection cage, can be affixed to said motorcycle via hardware or via more permanent means such as fabrication and welding.

The protective exoskeleton cage comprises a low profile design.

Close-fitting bends or angles in the exoskeleton frame are utilized to keep the frame close to the motorcycle frame thus prevent ground contact under tight leans and turns executed by the rider.

The cage mounts close to the frame The sliders are specifically located to preventing contact with the ground while leaning the motorcycle and turning, henceforth preventing hindrance of the motorcycles range of motion.

Supplementary internal supports can be added. Additional protection can be provided via internal bracing. A motor mount brace is incorporated in the design, which can be used supplementary with the exoskeleton shock absorption cage, providing extra support when necessary.

Due to the robust and shock absorption nature of said protective cage this product will not need to be replaced if a fall ensues. When force is applied to said cage, the force is absorbed by one or more shock absorbers built into the protective cage. No damage to the cage tubing or trusses will ensue.

The exoskeleton frame and engine bracket can be connected by threaded fasteners or it can be fabricated directly to the frame.

In the preferred embodiment the frame would be secured to the motorcycle via hardware.

In other embodiments the cage can be fabricated to the motorcycle frame.

In yet other embodiments the cage and the shock mechanism can be built into the motorcycle frame an OEM application and not as an additional item.

### BRIEF DESCRIPTION OF THE DRAWINGS

The aspects and features of various exemplary embodiments will be more apparent from the description of those exemplary embodiments taken with reference to the accompanying drawings, in which:

FIG. 1 is a perspective view of an exemplary shock absorption cage. Figure one shows one slider in the top position and one shock absorption apparatus in the bottom position. Mounting location of is directly below the top slider, at which the shock absorption cage is mounted to the motorcycle. This shock absorption cage could also be equipped with two shock absorption apparatuses or more. Shock absorption apparatus orientation may vary.

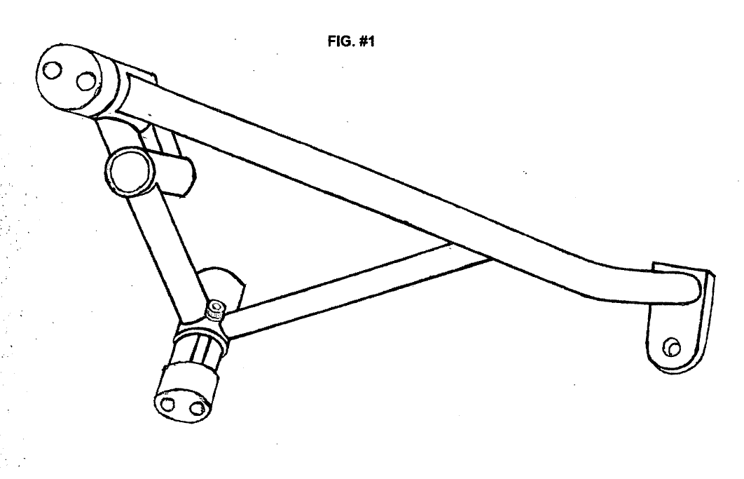

FIG. 2 is a side view of shock absorption exoskeleton frame of FIG. 1 installed on motorcycle.

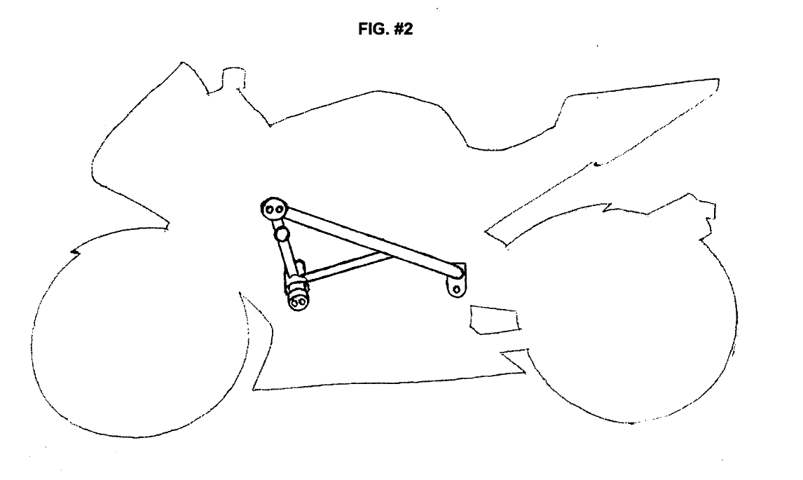

FIG. 3 is a perspective view of a shock absorption protective cage is where the top located shock absorber or slider is located directly above the frame mounting location and hardware.

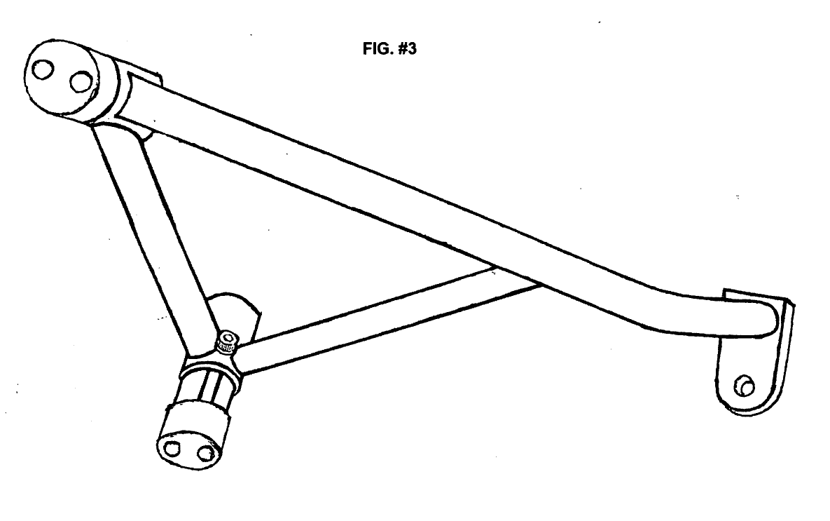

FIG. 4 is a view of shock absorption exoskeleton frame of FIG. 3 installed on a motorcycle.

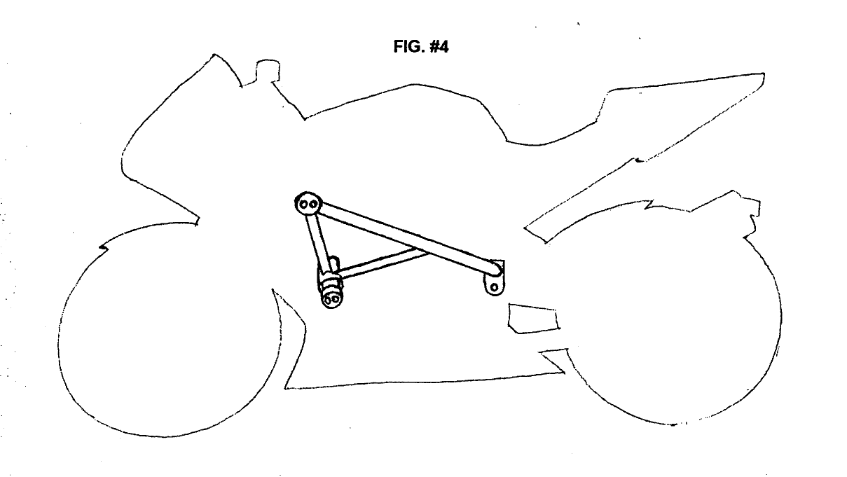

FIG. 5 is an exploded assembly view of the shock absorption apparatus; 1 is secured to 2 and is the shock absorbing housing. 1 has a hole in its central location in which the shock absorption frame to the motorcycle can be secured via hardware. Shock absorber 3 in this instance is a compressible inner foam material and is contacting hard outer material 4.

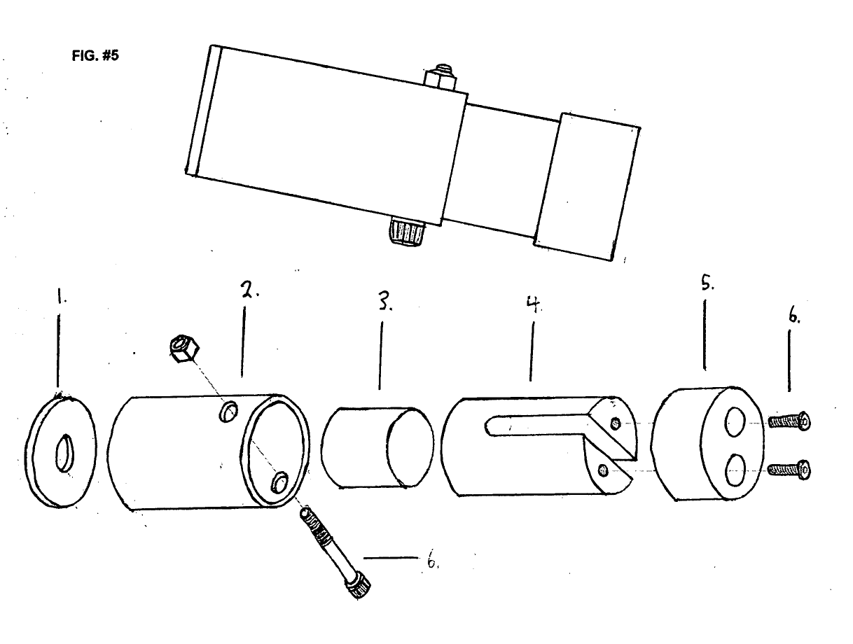

Housing 2 has a hole through its side so hardware 6 fits within the slot of hard outer material. Hardware 6 secures hard outer material 4 and compressible shock absorber 3 within housing 2. Friction pad 5 is secured to hard outer material 4 via hardware top 6.

FIG. 6 supporting engine mount bracket. This bracket is secured within OEM engine mounts providing additional protection to fragile engine mounting components is can be used supplementary with motorcycle shock absorption cage.

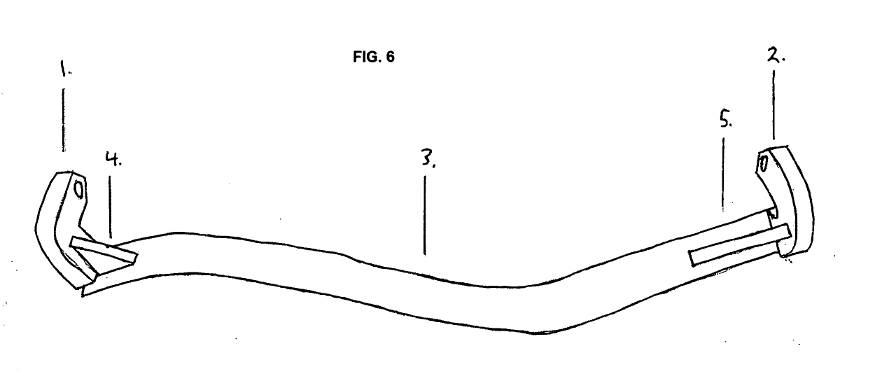

FIG. 7 supporting engine mount bracket secured to OEM motorcycle engine mounts.

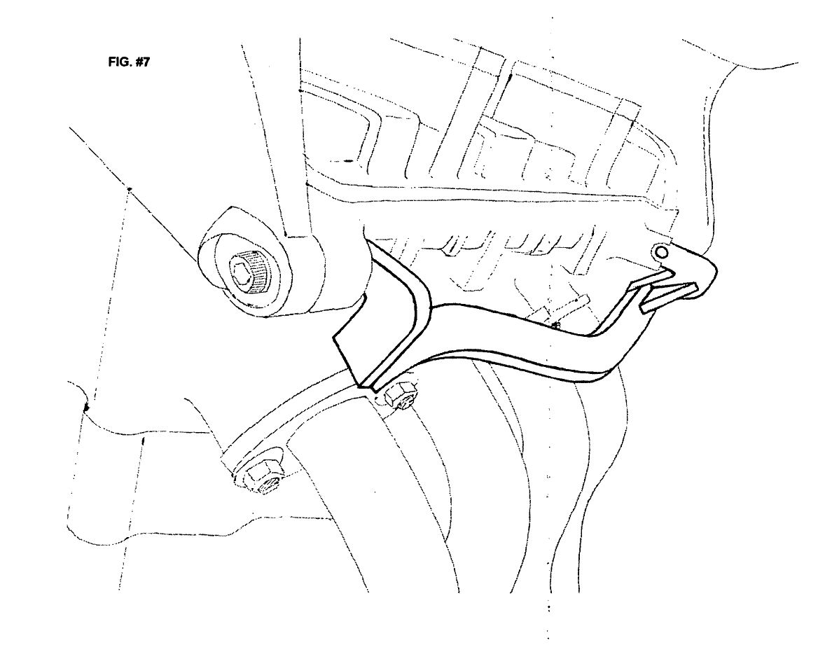

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to limit the invention to the exemplary embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present invention, and are not intended to limit the structure of the exemplary embodiments of the present invention to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments.

What is claimed:

1. A motorcycle shock absorption apparatus comprising:
A protective motorcycle cage with shock absorber apparatus. The cage rigidly attaches to the motorcycle, extending outward from the motorcycle and its components, while still remaining close to the motorcycle as to remain low profile and not hinder the riders' freedom of movement or the motorcycles range of motion. Said shock absorber apparatus consists of: the shock absorber housing, a hard durable outer material and a compressible inner shock absorber. Positioned underneath the hard outer material, contained within the shock absorber housing is the compressible inner shock absorber.
The outer material protrudes from the housing and is designed to make uniform contact with the ground before any other motorcycle component or other portion of the protective cage, subsequently protecting the motorcycle and its components from harmful force. Upon reception of force said hard outer material is pushed inside of the shock absorber housing, transferring force to the compressible shock absorber, henceforth absorbing and dissipating force.

2. The shock absorption cage in accordance of claim 1 wherein the cage is U-shaped, Y-shaped, V-shaped, or triangular and is consistent of supporting trusses therein.

3. The shock absorber apparatus of claim I, wherein one or more said shock absorber apparatuses and one or more stationary sliders is utilized therein.

4. The shock absorption apparatus of claim 1, wherein the housing is hollow and can be affixed to said protective cage via hardware.

5. The shock absorption apparatus of claim 1 wherein the housing can be affixed to said protective cage via fabrication such as welding or brazing.

6. The shock absorption apparatus of claim 1 comprising:
a. A hard outer material
b. A compressible foam or gel inner shock absorber

7. Shock absorption apparatus in accordance of claim 1 comprising:
a. A hard outer material
b. A compressible spring inner shock absorber

8. Apparatus in accordance of claim 1 comprising:
a. A hard outer material
b. A fluid shock comprising of liquid or gas inner shock absorber

9. The shock absorption apparatus of claim 1, wherein the shock absorption inner and/or outer materials are either plastic, polymer, reinforced plastic or reinforced polymer.

10. The shock absorption apparatus of claim 1, wherein said hard outer material has a slot cutout, in which a shaft or bolt is utilized therein securing hard outer material within said housing allowing for up and down movement of said hard outer material within the said housing.

11. The shock absorption cage of claim 1, wherein said protective cage mounts to said motorcycle frame directly underneath said shock absorption apparatus housing.

12. The shock absorption cage of claim 1, wherein said protective cage mounts to said motorcycle frame at a location distant from central location of shock absorption apparatus housing.

13. The shock absorption cage of claim 1, wherein a motorcycle engine mount is utilized for supplementary protection.

14. A motorcycle shock absorption apparatus comprising:
A protective motorcycle cage with shock absorber apparatus. The cage rigidly mounted to the motorcycle contains one or more shock absorption apparatuses. Said shock absorber apparatus consists of: the shock absorber housing, a replaceable friction pad fastened to a hard durable outer material, and an inner shock absorber. The friction pad is replaceable. Positioned underneath the hard outer material, contained within the shock absorber housing is the compressible inner shock absorber.
The friction pad receives force, consequently applying force to said hard outer material, which is forced inside of the shock absorber housing henceforth transferring force to the compressible inner shock absorber, thus absorbing force.

15. The shock absorption apparatus of claim 14, wherein friction pad is threadably fastened to said hard outer material.

16. The shock absorption apparatus of claim 14, wherein said friction pad can be fastened using hardware.

17. The shock absorption apparatus of claim 14, wherein said friction pad is metallic.

18. The shock absorption apparatus of claim 14, wherein said friction pad is either plastic, polymer, reinforced plastic or reinforced polymer.

19. The shock absorption apparatus of claim 14, wherein said friction pad is a reinforced plastic or polymer.
